(19) United States
(12) Patent Application Publication
(10) Pub. No.: US 2013/0086407 A1
(43) Pub. Date: Apr. 4, 2013

(54) ELECTRONIC APPARATUS AND POWER CONSUMPTION AMOUNT MEASURING METHOD

(71) Applicants: Shinsuke YATO, Akishima-shi (JP); Tooru MAMATA, Akiruno-shi (JP); Yoshio MATSUOKA, Ome-shi (JP)

(72) Inventors: Shinsuke YATO, Akishima-shi (JP); Tooru MAMATA, Akiruno-shi (JP); Yoshio MATSUOKA, Ome-shi (JP)

(73) Assignee: KABUSHIKI KAISHA TOSHIBA, Tokyo (JP)

(21) Appl. No.: 13/481,120

(22) Filed: May 25, 2012

(30) Foreign Application Priority Data
Sep. 30, 2011 (JP) 2011-218025

(51) Int. Cl. G06F 1/28

(52) U.S. Cl. 713/340

(57) ABSTRACT

According to one embodiment, an electronic apparatus includes a measuring module and a controller. The measuring module is configured to measure a power supplied from an external power supply during a period when the electronic apparatus is powered on or off. The controller is configured to output first data indicative of the power measured by the measuring module when the electronic apparatus is in a power-on state, temporarily record in a memory second data indicative of the power measured by the measuring module when the electronic apparatus is in a power-off state, and output the second data after the electronic apparatus transitions to the power-on state.

### CROSS-REFERENCE TO RELATED APPLICATIONS

This application is based upon and claims the benefit of priority from prior Japanese Patent Application No. 2011-218025, filed Sep. 30, 2011; the entire contents of which are incorporated herein by reference.

### FIELD

Embodiments described herein relate generally to an electronic apparatus which measures power consumption, and a power consumption amount measuring method.

### BACKGROUND

In recent years, the necessity for reducing power consumption in an electronic apparatus has been increasing. At the same time, the necessity for the function of visualizing the amount of power that is consumed in the electronic apparatus has been increasing.

Conventionally, in a personal computer, a utility program for power saving is executed, thereby making it possible to measure power consumption during operation, and to display a graph, or the like, representing the condition of power consumption, based on the measured value. Thus, the user can recognize the condition of power consumption.

In the conventional technology, a graph, or the like, representing the condition of power consumption in the personal computer can be displayed, but the display of power consumption is limited to the display of the power consumption during operation. Specifically, the condition of power consumption in a power-off state of the personal computer could not be recognized.

The power consumption in the power-off state of one personal computer is small. However, when the power consumption of the whole system including many personal computers is managed, the power consumption during the power-off period cannot be ignored. Conventionally, however, since the target of visualization is only the power consumption during operation, the power consumption during the period including a power-off period could not be recognized.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating an example of a personal computer according to an embodiment.

FIG. 2 is an exemplary block diagram illustrating a system configuration of the personal computer according to the embodiment.

FIG. 3 is an exemplary view illustrating a system which manages data of power consumption values in the embodiment.

FIG. 4 is an exemplary view illustrating data indicative of power consumption values which are recorded in a memory at a power-off time by an EC/KBC in the embodiment.

FIG. 5 is an exemplary flow chart illustrating a power consumption measuring process which is executed by the EC/KBC in the embodiment.

FIG. 6 is an exemplary view illustrating a measurement timing of power consumption values according to the states of the personal computer of the embodiment.

FIG. 7 is an exemplary flow chart illustrating a power consumption value data process by a power consumption amount measuring program in the embodiment.

FIG. 8A and FIG. 8B are exemplary views illustrating an example of a graph which is displayed by a data server in the embodiment.

FIG. 9 is an exemplary view illustrating an example of a graph which is displayed by the personal computer according to the embodiment.

### DETAILED DESCRIPTION

Various embodiments will be described hereinafter with reference to the accompanying drawings.

In general, according to one embodiment, an electronic apparatus comprises a measuring module and a controller. The measuring module is configured to measure a power amount, which is supplied from an external power supply, during a period in which the electronic apparatus is powered on/off. The controller is configured to output first data indicative of the power amount measured by the measuring module, when the electronic apparatus is in a power-on state, and to temporarily record, in a memory, second data indicative of the power amount measured by the measuring module, when the electronic apparatus is in a power-off state, and then output the second data after the electronic apparatus transitions to the power-on state.

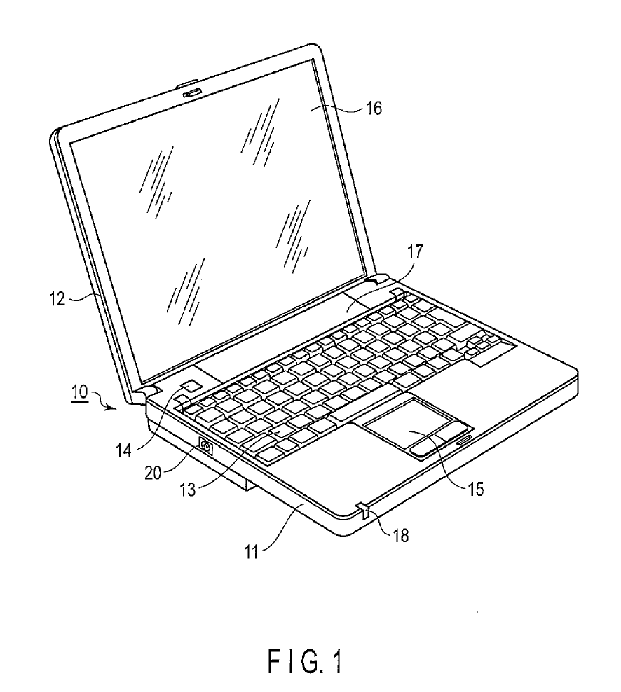

To begin with, referring to FIG. 1, a structure of an electronic apparatus according to an embodiment is described. This electronic apparatus is realized, for example, as a notebook-type portable personal computer 10 which can be driven by a battery. FIG. 1 is a perspective view showing the personal computer 10, as viewed from the front side, in the state in which a display unit is opened.

The personal computer 10 includes a computer main body 11 and a display unit 12. A display device, which is composed of an LCD 16 (Liquid Crystal Display), is built in the display unit 12.

The display unit 12 is supported on the computer main body 11. The display unit 12 is attached to the computer main body 11 such that the display unit 12 is rotatable between an operation position where the top surface of the computer main body 11 is exposed, and a closed position where the top surface of the computer main body 11 is covered with the display unit 12. The computer main body 11 has a thin box-shaped housing. A keyboard 13, a power switch 14 for powering on/off the personal computer 10, and a touch pad 15 are disposed on the top surface of the housing of the computer main body 11.

In addition, a power connector 20 is provided on the computer main body 11. The power connector 20 is provided on a side surface, for example, a left side surface, of the computer main body 11. An external power supply device is detachably connected to the power connector 20. As the external power supply device, an AC adapter can be used. The AC adapter is a power supply device which converts commercial power (AC power) to DC power.

The power connector 20 is composed of a jack to which a power plug, which is led out from the external power supply device such as an AC adapter, is detachably connected. A battery 17 is detachably attached to, for example, a rear end part of the computer main body 11.

The personal computer 10 is driven by power from the external power supply device, or by power from the battery 17. If the external power supply device is connected to the power connector 20 of the personal computer 10, the personal computer 10 is driven by power from the external power supply device. The power from the external power supply device is also used for charging the battery 17. The charging of the battery 17 may be executed, not only during the period in which the personal computer 10 is powered on, but also during the period in which the personal computer 10 is powered off. While the external power supply device is not connected to the power connector 20 of the personal computer 10, the personal computer 10 is driven by power from the battery 17.

In addition, the computer main body 11 is provided with an indicator 18 for indicating various power statuses, such as the presence/absence of the external power supply device. The indicator 18 is provided, for example, on the front surface of the computer main body 11. The indicator 18 may be composed of an LED.

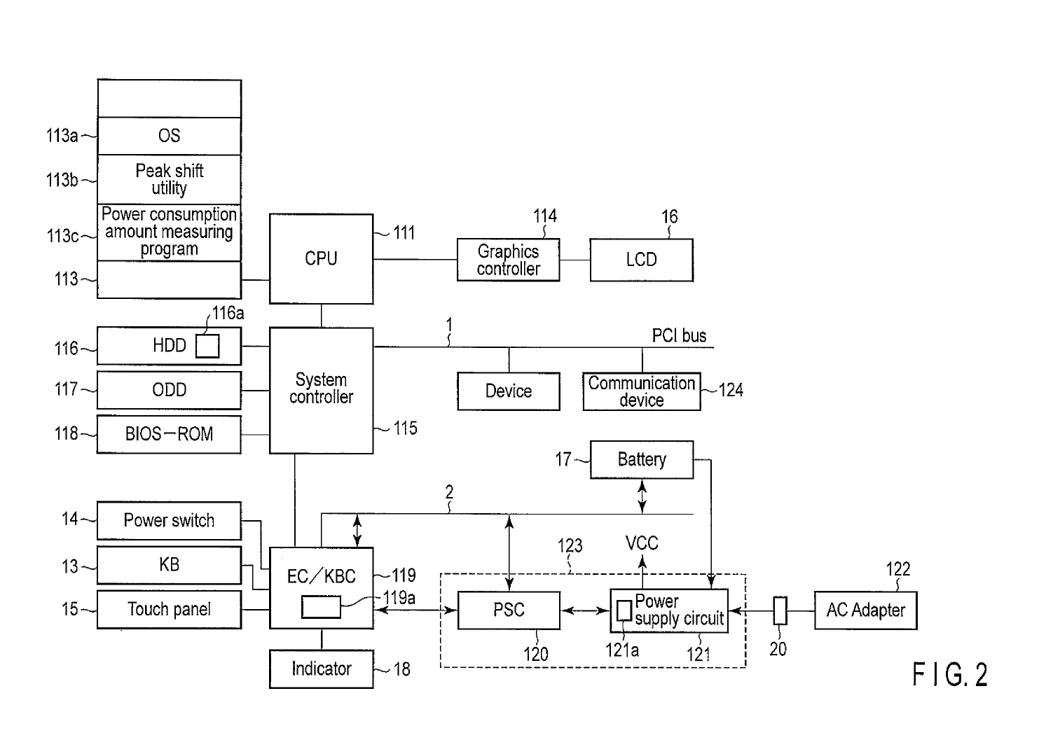

FIG. 2 illustrates the system configuration of the personal computer 10. The personal computer 10 includes a CPU 111, a main memory 113, a graphics controller 114, a system controller 115, a hard disk drive (HDD) 116, an optical disc drive (ODD) 117, a BIOS-ROM 118, an embedded controller/keyboard controller (EC/KBC) 119, a power supply controller (PSC) 120, a power supply circuit 121, and an AC adapter 122. The AC adapter 122 is used as the above-described external power supply device. In the present embodiment, the power supply controller (PSC) 120 and power supply circuit 121 function as a power consumption measuring circuit 123 for measuring the amount of power from the external power supply device (AC adapter). The power consumption measuring circuit 123 measures the power amount, not only during the period in which the personal computer 10 is powered on, but also during the period in which the personal computer 10 is powered off. In the present embodiment, the power that is supplied from the external power supply device (AC adapter) is treated as the power consumption in the personal computer 10. The EC/KBC 119 reads the power amount (current value, voltage value) measured by the power consumption measuring circuit 123, that is, data indicative of a power consumption value, and outputs the power amount to the CPU 111 (operating system (OS)) via the system controller 115.

The CPU 111 is a processor for controlling the operations of the respective components of the personal computer 10. The CPU 111 executes various software programs which are loaded from the HDD 116 into the main memory 113, such as an operating system (OS) 113a, various utility programs and various application programs.

The utility programs include a peak shift utility 113b for realizing a peak shift function. The peak shift function is a power supply management function by which, for example, during the peak time zone of power consumption in the society (e.g. daytime, in particular, 13:00 to 16:00 in the summer), the power supply from the external power supply device (AC adapter) is stopped and the driving by the external power supply device is switched to the driving by the battery, and the battery is charged in a time zone (nighttime) in which power consumption is low.

The application programs include a power consumption amount measuring program 113c for processing data indicative of a power consumption value which is measured by the power consumption measuring circuit 123. The power consumption amount measuring program 113c reads out, via the OS 113a, data indicative of a power consumption value recorded in a memory 119a (nonvolatile memory) of the EC/KBC 119, and records the read-out data in the HDD 116. In addition, the power consumption amount measuring program 113c executes a transmission process for transmitting the data indicative of the power consumption value recorded in the HDD 116 to an external device (e.g. a data server 30 to be described later), a data generation process for generating data which is to be transmitted to the external device, and a display process for displaying a screen (e.g. graph) representing a variation in power amount, based on the data indicative of the power consumption value. The data generation process includes a data complement process for obtaining a required data precision (data amount).

Besides, the CPU 111 executes a BIOS (Basic Input/Output System) which is stored in the BIOS-ROM 118 that is a nonvolatile memory. The BIOS is a system program for hardware control.

The graphics controller 114 is a display controller which controls the LCD 16 that is used as a display monitor of the personal computer 10.

The system controller 115 is connected to a PCI bus 1, and communicates with devices on the PCI bus 1. A communication device 124, for instance, is connected to the PCI bus 1. Under the control of the CPU 111, the communication device 124 controls communication with an external device (e.g. data server 30) via a network. In addition, the system controller 115 incorporates a Serial ATA controller for controlling the hard disk drive (HDD) 116 and optical disc drive (ODD) 117.

The EC/KBC 119, power supply controller (PSC) 120 and battery 17 are interconnected via a serial bus 2 such as an I2C bus, and are connected to the system controller 115 via an LPC bus. The EC/KBC 119 is a power supply management controller for executing power management of the personal computer 10, and is realized, for example, as a one-chip microcomputer which incorporates a keyboard controller for controlling the keyboard (KB) 13 and touch pad 15. The EC/KBC 119 has a function of powering on/off the personal computer 10 in accordance with the user's operation of the power switch 14. The power on/off control of the personal computer 10 is executed by cooperation between the EC/KBC 119 and PSC 120. Upon receiving an ON signal which is transmitted from the EC/KBC 119, the PSC 120 controls the power supply circuit 121, thereby turning on the respective internal power supplies in the personal computer 10. In addition, upon receiving an OFF signal which is transmitted from the EC/KBC 119, the PSC 120 controls the power supply circuit 121, thereby turning off the respective internal power supplies in the personal computer 10. The EC/KBC 119, PSC 120 and power supply circuit 121 operate by power from the battery 17 or AC adapter 122, even while the personal computer 10 is in the power-off state.

The power supply circuit 121 generates power (operation power) which is to be supplied to the respective components, by using power from the battery 17 which is attached to the computer main body 11, or power from the AC adapter 122 which is connected to the computer main body 11 as the external power supply. When the AC adapter 122 is connected to the computer main body 11, the power supply circuit 121 generates operation power to the respective components by using power from the AC adapter 122, and turns on a charging circuit (not shown) to charge the battery 17. The power supply circuit 121 includes a detection circuit 121a which outputs signals indicative of a voltage value and a current value of the AC adapter 122 and a voltage value and a current value of the battery 17. Based on the signals that are output from the detection circuit 121a, the PSC 120 generates data indicative of the current value/voltage value of the AC power supply, and data indicative of the current value/voltage value of the battery 17.

The EC/KBC 119, PSC 120 and power supply circuit 121 in the embodiment execute an operation for measuring data indicative of a power consumption value measured by the power consumption measuring circuit 123 and recording this data, not only during the period in which the personal computer 10 is powered on, but also during the period in which the personal computer 10 is powered off.

During the period in which the personal computer 10 is powered on, the EC/KBC 119 immediately outputs the data, which is indicative of the power consumption value that is input from the PSC 120, to the CPU 111 (OS 113a, power consumption amount measuring program 113c) via the system controller 115, and the power consumption amount measuring program 113c records this data in the HDD 116. On the other hand, during the period in which the personal computer 10 is powered off, the EC/KBC 119 temporarily stores the data, which is indicative of the power consumption value that is input from the PSC 120, in the internal memory 119a, and outputs this data, at the next power-on time, to the CPU 111 (OS 113a, power consumption amount measuring program 113c) via the system controller 115, and the power consumption amount measuring program 113c records this data in the HDD 116.

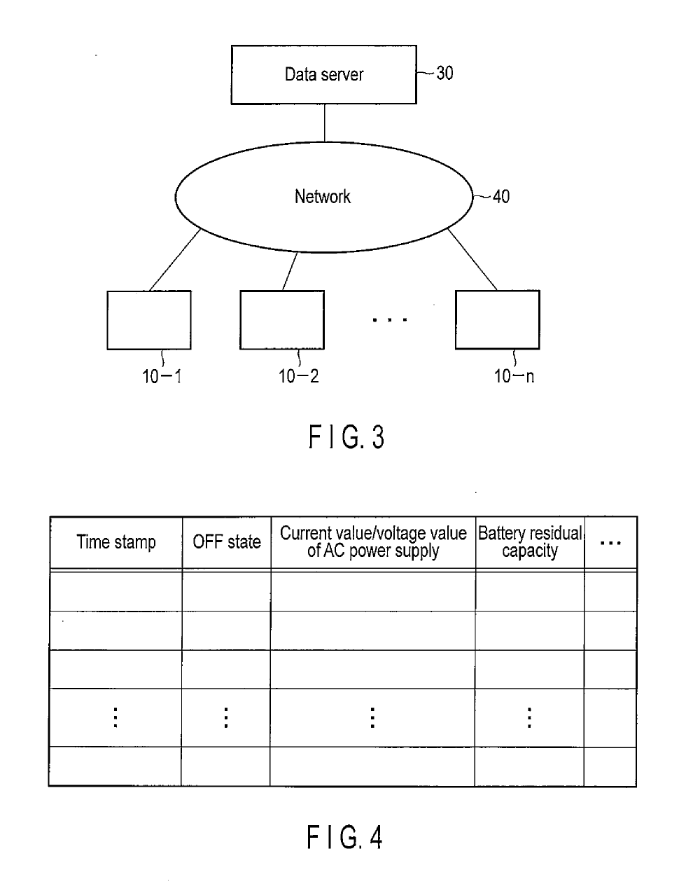

FIG. 3 is an exemplary view illustrating a system which manages data of power consumption values measured by the personal computer 10.

A plurality of personal computers 10 (10-1, 10-2, . . . , 10-n) are connected to a data server 30 via a network 40. The data server 30 collects data of power consumption values of plural personal computers 10, for example, in a company, thereby managing the power consumption of the personal computers 10 in the company as a whole.

The data server 30 totalizes the data of the power consumption values, which have been received from the plural personal computers 10, and generates data, etc. for displaying a graph, or the like, which represents the condition of the power consumption.

FIG. 4 is an exemplary view illustrating data indicative of power consumption values which are recorded in the memory 119a at a power-off time by the EC/KBC 119 in the embodiment.

As shown in FIG. 4, “OFF state” (power supply state) at a data recording time, data indicative of a current value/voltage value of the AC power supply (AC adapter 122) and data indicative of a battery residual capacity are recorded in a time-series manner in association with time stamps indicative of time points at which data is recorded. It is assumed that one of system state S3 (wakeup enabled/disabled) which is called “standby/sleep/suspend”, system state S4 which is called “hibernation” and system state S5 (wakeup enabled/disabled) which is called “shutdown”, is set in “OFF state”.

The memory 119a of the EC/KBC 119 has only a small recording capacity of, e.g. several KB. Thus, in order to prevent overflow of the memory 119a, the EC/KBC 119 reduces the data amount by varying the frequency of data recording, in accordance with the power state (ON/OFF), the connection state of the AC adapter 122, and the battery state (“Charging”, “Full”, “Discharging”). For example, when the personal computer 10 is in the power-off state, a first period in which a variation in power consumption is small and a second period in which a variation in power consumption is large are discriminated, and data is recorded by measuring the power amount at time points of the beginning and end of the first period, and measuring the power amount each time a specified time (e.g. a predetermined time) has passed during the second period.

The first period in which a variation in power consumption is small is, for example, a period in which power consumption can be regarded as being substantially constant. Examples of the first period include a period in which the battery is fully charged, a period in which the AC adapter 122 is not connected, and a period in which the battery 17 is detached from the personal computer 10. Accordingly, the time points of the beginning and end of the first period are time points of insertion/removal of the AC adapter 122, detachment/attachment of the battery 17, and detection of the fully charged state of the battery 17. The second period, in which a variation in power consumption is larger than in the first period, includes, for example, a charging period of the battery 17 (the period in which the AC adapter 122 is connected and the battery 17 is not in the fully charged state).

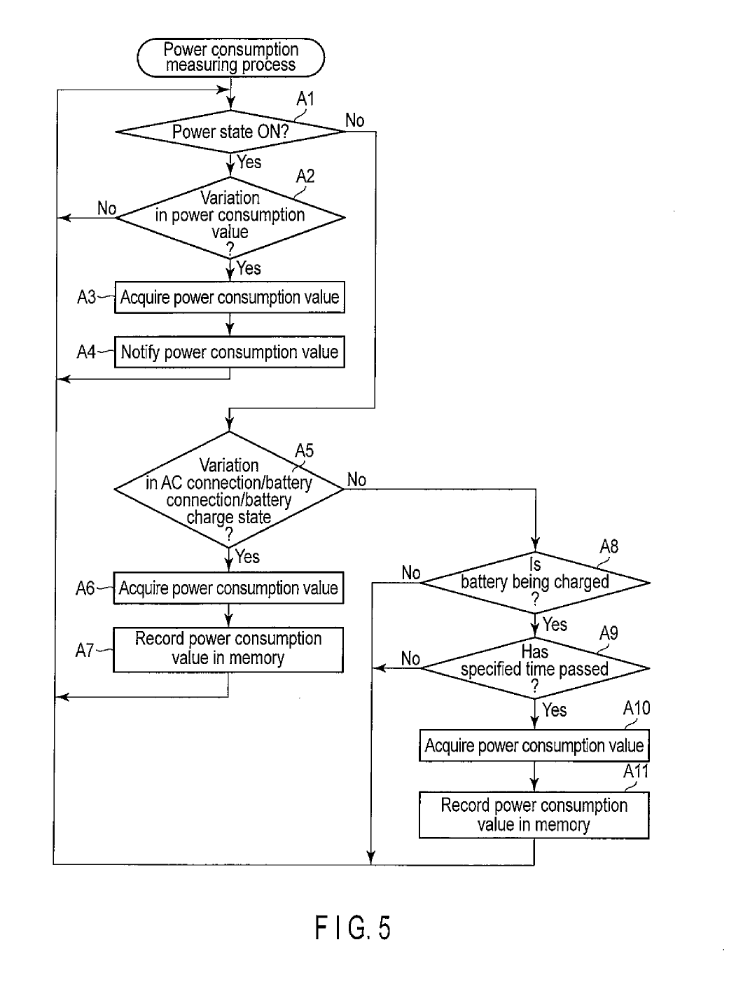

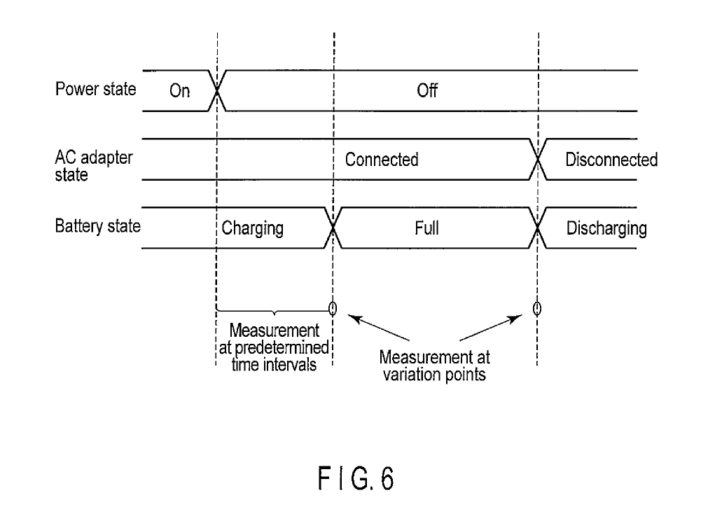

Next, referring to a flow chart of FIG. 5, a description is given of a power consumption measuring process which is executed by the EC/KBC 119 in the embodiment. FIG. 6 illustrates a timing of measuring power consumption values according to the combination of the state of the personal computer 10, the state of the AC adapter 122 and the state of the battery.

During the period in which the power state of the personal computer 10 is “ON”, that is, in the power-on state (Yes in block A1), if the power consumption value measured by the power consumption measuring circuit 123 (PSC 120) has varied (Yes in block A2), the EC/KBC 119 acquires data indicative of a power consumption value (block A3). In the power-on state, the EC/KBC 119 immediately notifies the data indicative of the power consumption value to the CPU 111 (OS 113a, power consumption amount measuring program 113c) via the system controller 115, without recording this data in the memory 119a (block A4).

The power consumption amount measuring program 113c records, via the OS 113a, the data indicative of the power consumption value that has been input from the EC/KBC 119, in a nonvolatile recording device, for example, the HDD 116.

On the other hand, when the power state of the personal computer 10 is “OFF”, that is, in the power-off state (No in block A1), the EC/KBC 119 records data indicative of a power consumption value, which has been measured by the power consumption measuring circuit 123, in the memory 119a at a timing corresponding to a combination of the power state, the state of the AC adapter 122 and the battery state. In the memory 119a, as shown in FIG. 4, the OFF state (S3, S3/S4) and the data indicative of the battery residual capacity, in addition to the data of the current value/voltage value of the AC power supply, are recorded in association with time stamps (in the description below, a description of the details of the data recording in the memory 119a is omitted).

When the AC adapter 122 is connected and the battery 17 is not in the fully charged state, the battery 17 is charged. Specifically, this time corresponds to the second period and, as shown in FIG. 6, during the battery charging (Yes in block A8), each time a specified time has passed (Yes in block A9), the EC/KBC 119 acquires data indicative of a power consumption value from the power consumption measuring circuit 123 and records this data in the memory 119a (block A10, A11). In this case, it is assumed that the specified time is a predetermined fixed time. Accordingly, data indicative of power consumption values at predetermined time intervals are recorded in the memory 119a. The predetermined fixed time is, for instance, 5 minutes.

In the meantime, the interval of measuring the power consumption amount is set such that no overflow of the memory 119a occurs by recording, in the memory 119a of the EC/KBC 119, the data indicative of power consumption values which are read at regular intervals during the second period (power-off) that is assumed when the personal computer 10 is usually used.

The specified time is not limited to the predetermined fixed time, and may be set to be variable during the second period. For example, when the charge amount of the battery 17 is low, the amount of charging per unit time is large. Thus, the power consumption amount is measured at short intervals. When the charge amount of the battery 17 has reached a predetermined level (e.g. 90% or more), the power consumption amount is measured at long intervals. Specifically, the amount of data can be reduced by decreasing the frequency of measurement when the power consumption is low during the second period.

If the EC/KBC 119 is notified by the PSC 120 that the battery 17 has been in the fully charged state (Yes in block A5), the EC/KBC 119 acquires the data indicative of a power consumption value at this time point (block A6) and records this data in the memory 119a (block A7). Specifically, when the battery 17 has transitioned to the fully charged state, the state of the battery 17 corresponds to the first period in which power consumption can be regarded as being constant (i.e. a variation in power consumption is small). Thus, the power consumption value is recorded at the time point of the beginning of the first period. Then, while the battery 17 is in the fully charged state (i.e. while the battery charge state does not vary), the EC/KBC 119 does not record data indicative of a power consumption value.

When the personal computer 10 is powered on (Yes in block A1), the EC/KBC 119, as described above, outputs the data indicative of the power consumption value in the power-on state to the OS 113a, thereby recording this data in the HDD 116 (blocks A1 to A4). In the HDD 116, time-series data 116a, which is output from the EC/KBC 119, is recorded.

On the other hand, if it is detected, while the battery 17 is in the fully charged state, that the AC adapter 122 has been disconnected or that the battery 17 has been detached (Yes in block A5), the EC/KBC 119 acquires data indicative of a power consumption value at this time point from the power consumption measuring circuit 123 (block A6) and records this data in the memory 119a (block A7). In other words, the EC/KBC 119 measures the power consumption amount at the time point of the end of the first period, and records this power consumption amount. Thereafter, since the state in which the AC adapter 122 is not connected, or the state in which the battery 17 is detached, corresponds to the first period, the EC/KBC 119 does not record data indicative of a power consumption value during this period.

In addition, when the AC adapter 122 has been connected or when the battery 17 has been attached (Yes in block A5), the EC/KBC 119 acquires data indicative of a power consumption value from the power consumption measuring circuit 123 and records this data in the memory 119a (block A6, A7).

In this manner, even when the personal computer 10 is in the power-off state, the data indicative of a power consumption value, which has been measured by the power consumption measuring circuit 123, can temporarily be recorded in the memory 119a of the EC/KBC 119. The data recorded in the memory 119a is read out when the power consumption amount measuring program 113c (to be described later) is started.

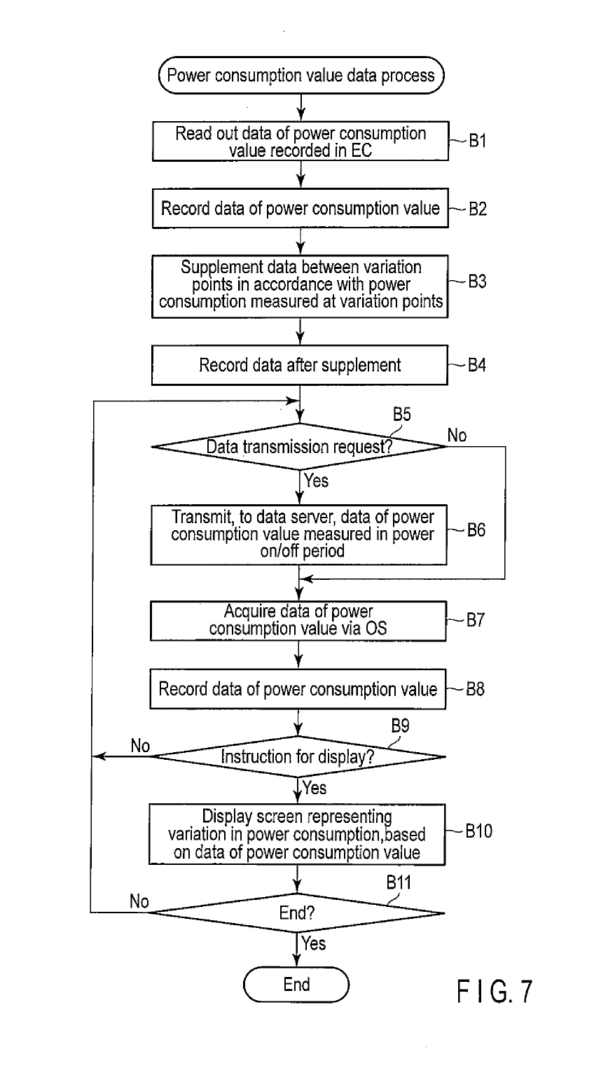

Next, referring to a flow chart of FIG. 7, a description is given of a power consumption value data process by the power consumption amount measuring program 113c in the embodiment.

If the personal computer 10 is powered on, the power consumption amount measuring program 113c is started. The CPU 111 executes the power consumption value data process, based on the power consumption amount measuring program 113c.

To start with, the power consumption amount measuring program 113c reads out the data indicative of the power consumption value recorded in the memory 119a of the EC/KBC 119 (block B1), and records this data in the HDD 116 such that this data merges with the data 116a which was recorded in the HDD 116 in the power-on period (block B2).

Subsequently, the power consumption amount measuring program 113c complements necessary data, based on the data indicative of the power consumption value measured during the power-off time (block B3). Specifically, based on the data indicative of the power consumption values measured at the time points (variation points) of the beginning and end of the first period, the power consumption amount measuring program 113c complements data between the variation points.

When the personal computer 10 is in the power-off state, all power supplies, except power supplies for the EC/KBC 119, PSC 120 and power supply circuit 121 which are operated for the activation from the power-off, are turned off (however, power to the main memory 113 is turned on in the OFF state in which data stored in the main memory 113 is backed up, and power to modules relating to wakeup is turned on in the OFF state in which wakeup is enabled).

Specifically, in the power-off state, since the power supply to most of the modules, which constitute the personal computer 10, is turned off, the power consumption of the personal computer 10, as a whole, is very low. In usual cases, since the power consumption measuring circuit 123 is configured based on constants for measuring power consumption in the power-on state, a non-negligible error occurs when a very low power consumption is measured. It is technically possible to add a circuit for precisely measuring power consumption in the power-off state, but this leads to an increase in cost in the personal computer 10 of this embodiment. Thus, such addition of a circuit is not adopted in this embodiment.

Taking the above into account, during the first period in which power consumption is very low and a variation in power consumption is small, data between the beginning and end of the first period is complemented based on the power consumption measured at the time points of the beginning and end of the first period. Thereby, the effect of a measurement error during the period, in which the power consumption is very low, is avoided. In the second period, since the battery 17 is being charged, the power consumption of the AC power supply becomes larger than in the first period. Thus, a measurement error becomes relatively small, and data with a target measurement precision can be obtained.

In the meantime, in this case, it is possible not only to complement the data in the first period, but also to generate data of a format which is required for the data that is transmitted to the data server 30. For example, it is assumed that the data, which is transmitted from the personal computer 10 to the data server 30, has a format comprising “Time”, “Power”, “interval”, “Capacity” and “State”.

“Time” is indicative of the date and time of measurement of data, “Power” is indicative of accumulated power (mWh) from immediately previous data, “Interval” is indicative of a driving time (sec) from immediately previous data, “Capacity” is indicative of a battery residual capacity (mWH), and “State” is indicative of a system state. Based on the data from the EC/KBC 119, the power consumption amount measuring program 113c generates data corresponding to the above-described format with the precision which is required by the data server 30.

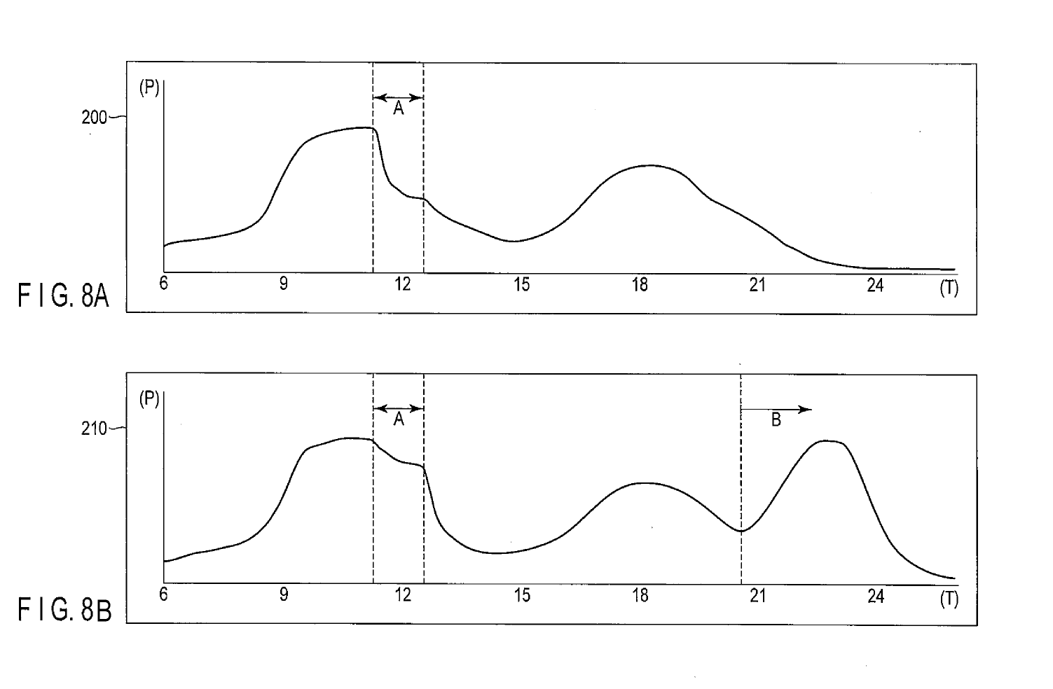

Then, upon receiving a data transmission request from the data server 30 via the network (Yes in block B5), the power consumption amount measuring program 113c transmits to the data server 30 the data that is indicative of power consumption values measured in the power on/off period (block B6). This data may be data (data after complement) that is input via the EC/KBC 119, or data that is generated in accordance with the format required for the data server 30. A description will be given later of the handling of the data which has been received in the data server 30 from the personal computer 10 (see FIG. 8A and FIG. 8B).

In addition, at a normal operation time, the power consumption amount measuring program 113c acquires, via the OS 113a, the data indicative of the power consumption value that is output from the EC/KBC 119 (block B7), and records this data in the HDD 116 (block B8).

Then, upon receiving an instruction to display a screen representing a variation in power consumption by the user of the personal computer 10 (Yes in block B9), the power consumption amount measuring program 113c generates, for example, a graph representing a variation in power consumption, based on the data 116a indicative of the power consumption value recorded in the HDD 116, and causes the LCD 16 to display the graph (block B10).

The power consumption amount measuring program 113c executes the process of blocks B5 to B10 until the end of the process is instructed by the user or the power is turned off (block B11).

FIG. 8A and FIG. 8B show examples in which a graph representing a variation in power consumption is displayed in the data server 30, for example, based on the data indicative of the power consumption values which have been received from plural personal computers 10 in the company.

A graph displayed on a screen 200 in FIG. 8A illustrates an example of the case in which power consumption during power-off of the personal computer 10 is not measured.

In the screen 200, the power consumption lowers at about 12:00 (range A in FIG. 8A). Since a rest break is provided at about 12:00 in the company, many persons power off personal computers 10 in the rest break. Thus, when the power consumption value is not measured during the period of the power-off state, the power consumption greatly lowers.

A graph displayed on a screen 210 in FIG. 8B illustrates an example of the case in which power consumption during power-off of the personal computer 10 is measured. When the power consumption value is measured also during the power-off period of the personal computer 10, the power consumption due to, for example, the charging of the battery 17 during the power-off, is measured, and the measured value is reflected in the graph. Thus, as shown in the screen 210, the power consumption value in the range A in FIG. 8B becomes higher than in the screen 200.

In addition, it is assumed that a peak shift function is executed in the personal computer 10 by the peak shift utility 113b. Thus, for example, during the period of 13:00 to 18:00 (the time can arbitrarily be set in each personal computer 10), the personal computer 10 is driven by the battery 17. Accordingly, the power consumption greatly lowers.

In the screen 200, the power consumption during the period in which the personal computer 10 is in the power-off state is not measured. Thus, the power consumption after, e.g. 21:00, decreases.

When the charging of the battery 17 is set at a time after 21:00 by the peak shift function, the charging of the battery 17 is executed after 21:00 when the personal computer 10 is powered off. Accordingly, by measuring the power consumption at the power-off time, the power consumption due to the charging of the battery 17 is reflected in the graph, as indicated by an area B in the screen 210.

By measuring the power consumption during the power-off of the personal computer 10, as described above, the condition of the power consumption, including power consumption at the power-off time, can be recognized.

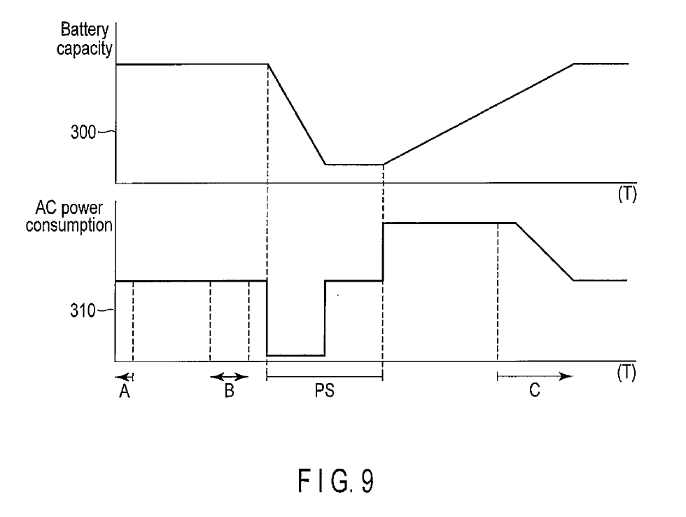

FIG. 9 shows an example of a screen in the case in which the display of a screen representing a variation in power consumption has been instructed by the user in the personal computer 10. A graph shown in FIG. 9 conceptually illustrates variations in battery capacity (residual capacity) and AC power consumption, and does not illustrate an actual measurement result by the personal computer 10.

A graph 300 shows a residual capacity of the battery 17, and a graph 310 shows a variation in AC power consumption. The power consumption amount measuring program 113c creates and displays a graph, based on the time-series data 116a indicative of power consumption values which have been input from the EC/KBC 119.

The graph 300 indicates that the battery residual capacity greatly lowers in the time zone (range PS in FIG. 9) in which the battery driving is executed by, e.g. the peak shift function. In addition, in the graph 310, the AC consumption power lowers in the time zone in which the battery driving is executed by the peak shift function. In the example shown in FIG. 9, the AC power consumption increases by the charging of the battery 17, after the time zone in which the battery driving is executed by the peak shift function.

When the power consumption value is not measured in the power-off state in the personal computer 10, for example, before the beginning of working hours (before A in FIG. 9), during a lunch break (period B in FIG. 9) or during nighttime (after C in FIG. 9) in which the personal computer 10 is not used, the display indicates that there is no power consumption. However, in the personal computer 10 in the present embodiment, since the power consumption is continuously measured even after the power state has transitioned from the power-on state to the power-off state, successive variations in power consumption during the period including the power-off period, can be presented to the user.

As described above, in the personal computer 10 of the embodiment, the power consumption amount during the power-off can be measured by using the memory 119a for lower consumption in the EC/KBC 119. Thereby, it is possible to recognize the power consumption in the states including not only the power-on state but also the power-off state of the personal computer 10.

In the above description, the predetermined fixed time is set in accordance with the capacity of the memory 119a, thereby to prevent overflow of the data indicative of power consumption values which are measured in the period (second period) in which power consumption varies while the personal computer 10 is in the power-off state. Alternatively, the interval for recording of the data indicative of power consumption values may be set, regardless of the capacity of the memory 119a. In this case, it is possible that in the power-off state, data cannot be recorded (“overflow”) in the memory 119a of the EC/KBC 119. When overflow is likely to occur (i.e. when the free space of the memory has decreased below a predetermined value), the EC/KBC 119 turns on the personal computer 10, thereby starting the power consumption amount measuring program 113c. The EC/KBC 119 outputs the data, which is recorded in the memory 119a, to the power consumption amount measuring program 113c via the OS 113a. The power consumption amount measuring program 113c records the data indicative of the power consumption value from the EC/KBC 119 in the HDD 116. In addition, the power consumption amount measuring program 113c releases a recording area of the memory 119a of the EC/KBC 119, so that data of new power consumption values may be recorded. Thereafter, the power consumption amount measuring program 113c sets the personal computer 10 in the power-off state. In this manner, even when deficiency occurs in the capacity of the memory 119a, missing of data measured in the second period can be avoided.

In addition, although the above description is directed to the personal computer, the embodiment is applicable to other electronic apparatuses. For example, the embodiment can be applied to a TV in which a battery is mounted.

In the above description, the data of the measured power consumption is recorded by the EC/KBC 119 which operates even while the personal computer 10 is inoperative (power-off). However, a power consumption measuring process, which is similar to the above-described power consumption measuring process by the EC/KBC 119, can be executed by other modules which operate even in the power-off state.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

The process that has been described in connection with the present embodiment may be stored as a computer-executable program in a recording medium such as a magnetic disk (e.g. a flexible disk, a hard disk), an optical disk (e.g. a CD-ROM, a DVD) or a semiconductor memory, and may be provided to various apparatuses. The program may be transmitted via communication media and provided to various apparatuses. The computer reads the program that is stored in the recording medium or receives the program via the communication media. The operation of the apparatus is controlled by the program, thereby executing the above-described process.

1. An electronic apparatus comprising:
a measuring module configured to measure power supplied from an external power supply at a start point and an end point of a first period when a variation in power consumption is smaller than a predetermined value, when the electronic apparatus is in a power-off state; and
a storage module configured to store first data indicating the power measured by the measuring module.

2. The electronic apparatus of claim 1, wherein when the electronic apparatus is in the power-off state, the measuring module is configured to measure the power each time a predetermined time passes during a second period when the variation in power consumption is greater than in the first period.

3. The electronic apparatus of claim 2, further comprising a battery charged by the power supplied from the external power supply,
wherein the first period is a period when the battery is fully charged, supply of power from the external power supply is stopped, or the battery is not usable, and
the second period is a period when the battery is charging.

4. The electronic apparatus of claim 2, further comprising a complement module configured to complement third data in the first period based on the first data.

5. The electronic apparatus of claim 4, further comprising a transmitter configured to transmit the first data and third data to an external device.

6. The electronic apparatus of claim 4, further comprising a display configured to display a screen representative of a variation in power based on the first data and the third data.

7. A method of measuring power consumption of an electronic apparatus that is supplied with power from an external power supply, comprising:
measuring the power supplied from the external power supply at a start point and an end point of a first period when a variation in power consumption is smaller than a predetermined value, when the electronic apparatus is in a power-off state; and
storing first data indicating the measured power.

8. The method of claim 7, wherein when the electronic apparatus is in the power-off state, the power is measured each time a predetermined time passes during a second period when the variation in power consumption is greater than in the first period.

9. The electronic apparatus of claim 1, wherein the measuring module is configured to measure the power supplied from the external power supply when the electronic apparatus is in a power-on state; and
further comprising a controller configured to:
output second data indicative of the power measured by the measuring module when the electronic apparatus is in the power-on state, and
output the first data after the electronic apparatus transitions from the power-off state to the power-on state.

10. The electronic apparatus of claim 1, wherein the power consumption includes consumption of power externally charged in a battery.

11. The method of claim 7, wherein
the measuring module is configured to measure the power supplied from the external power supply and to output second data indicative of the measured power, when the electronic apparatus is in a power-on state; and
the first data is output after the electronic apparatus transitions from the power-off state to the power-on state.

12. The method of claim 7, wherein the power consumption includes consumption of power externally charged in a battery.
